(19) United States
(12) Patent Application Publication
(10) Pub. No.: US 2026/0278069 A1
(43) Pub. Date: Sep. 17, 2026

(54) DYNAMIC ISOLATED MEMORY COMPARTMENTALIZATION FOR AI-ENABLED IOT DEVICES

(71) Applicant: INTERNATIONAL BUSINESS MACHINES CORPORATION, Armonk, NY (US)

(72) Inventors: Namit Kabra, HYDERABAD (IN); Sarbajit Kumar Rakshit, KOLKATA (IN); Manish Anand Bhide, HYDERABAD (IN)

(21) Appl. No.: 19/080,108

(22) Filed: Mar. 14, 2025

(51) Int. Cl. G06F 21/53; G06F 21/55

(52) U.S. Cl. CPC G06F 21/53; G06F 21/554; G06F 2221/034

(57) ABSTRACT

A method, system, and computer program product configured to perform operations including: defining isolated memory compartments in a memory of an Internet of Thing (IoT) device using a security capability architecture; determining a current operational context associated with the IoT device based on data from one or more sensors embedded in the IoT device; detecting a threat associated with a respective one of the isolated memory compartments based on the current operational context and the data from the one or more sensors; and dynamically adjusting a size of the respective one of the isolated memory compartments based on the detecting the threat.

### BACKGROUND

Aspects of the present invention relate generally to cybersecurity and, more particularly, to cybersecurity in computer memory systems.

Compartmentalization is a cybersecurity approach that divides memory into isolated compartments, restricting unauthorized access between them. Current implementations of compartmentalization utilize static memory allocations to define compartments.

### SUMMARY

In a first aspect of the invention, there is a method including: defining isolated memory compartments in a memory of an Internet of Thing (IoT) device using a security capability architecture; determining a current operational context associated with the IoT device based on data from one or more sensors embedded in the IoT device; detecting a threat associated with a respective one of the isolated memory compartments based on the current operational context, the detection of threats from machine learning (ML) algorithms, and the data from the one or more sensors; and dynamically adjusting a size of the respective one of the isolated memory compartments based on the detecting the threat.

In another aspect of the invention, there is a computer program product comprising one or more computer-readable storage media and program instructions stored on the one or more computer-readable storage media to perform operations comprising: defining isolated memory compartments in a memory of an Internet of Thing (IoT) device using a security capability architecture; determining a current operational context associated with the IoT device based on data from one or more sensors embedded in the IoT device; detecting a threat associated with a respective one of the isolated memory compartments based on the current operational context the data from the one or more sensors, and using one or more ML algorithms; dynamically adjusting a size of the respective one of the isolated memory compartments based on the detecting the threat; quarantining the respective one of the isolated memory compartments based on the detecting the threat; and rolling back the respective one of the isolated memory compartments to a previous safe state based on the detecting the threat.

In another aspect of the invention, there is a computer system comprising a processor set, one or more computer-readable storage media, and program instructions stored on the one or more computer-readable storage media to cause the processor set to perform operations comprising: defining isolated memory compartments in a memory of an Internet of Thing (IoT) device using a security capability architecture; determining a current operational context associated with the IoT device based on data from one or more sensors embedded in the IoT device; dynamically adjusting a size of one or more of the isolated memory compartments based on the current operational context; and periodically shuffling memory addresses in each of the isolated memory compartments.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

### DETAILED DESCRIPTION

Aspects of the present invention relate generally to cybersecurity and, more particularly, to cybersecurity in computer memory systems. Implementations of the invention introduce methods and systems that provide dynamic isolated memory compartmentalization for artificial intelligence (AI) enabled Internet of Thing (IoT) devices, leveraging CHERI (Capability Hardware Enhanced RISC (reduced instruction set computer) Instructions). In various embodiments, the dynamic isolated memory compartmentalization comprises context-aware memory allocation in which the system monitors operational context through embedded sensors, ML algorithms trained to detect unusual access patterns, and user history and adjusts memory allocation based on the perceived risk level. For example, implementations may perform context-based memory management that adjusts memory allocation not only based on detected threats but also on the specific operational context (e.g., the IoT device location, time of day, presence of nearby devices, purpose of data uses, etc.) to ensure the memory boundaries are optimally configured based on identified context and security.

In various embodiments, the dynamic isolated memory compartmentalization further comprises real-time threat detection in which AI algorithms are utilized to continuously analyze memory access patterns and detect abnormal behaviors, such as buffer overflow attempts. In various embodiments, the dynamic isolated memory compartmentalization further comprises the system automatically reducing the memory allocation for a compromised compartment in response to detecting a suspicious activity, thereby limiting their ability to affect other parts of the system. In various embodiments, the dynamic isolated memory compartmentalization further comprises self-healing mechanisms in which the system incorporates autonomous isolation and recovery features, which contain threats and restore compartments to their last safe state. In various embodiments, the dynamic isolated memory compartmentalization further comprises a moving target defense in which a runtime address randomization mechanism is implemented to alter memory addresses dynamically, complicating potential exploitation by attackers.

The rapid proliferation of IoT devices has led to an increased need for robust security mechanisms to protect sensitive data and maintain system integrity. Traditional security measures, such as static memory allocation and fixed boundary compartmentalization, are often insufficient to address the dynamic and complex threat landscape faced by modern IoT systems. For example, traditional security measures have static memory allocation which suffers from the drawback of being unable to respond to dynamic risks. Traditional security measures also suffer from context insensitivity in which their absence of real-time context awareness increases the likelihood of a successful cyber-attack on the IoT device. Traditional security measures also suffer from a lack of dynamic response, meaning that existing methods do not adjust to runtime threats and, as a result, leave data exposed to such threats. Traditional security measures also suffer from not having self-recovery, meaning that the systems lack mechanisms to autonomously recover from compromises, thereby allowing threats to propagate.

Implementations of the invention provide a solution to these problems by providing an adaptive, context-aware compartmentalization system that actively responds to evolving threats, isolates compromised isolated memory compartments and includes self-recovery capabilities. In various embodiments, the solution comprises a isolated memory compartmentalization system that includes: a context-aware monitoring module utilizing sensor data to determine the operational context of an IoT device; a memory management module that dynamically adjusts memory allocation within hardware-enforced compartments based on real-time context changes; and an access control module that restricts memory interactions between compartments to limit the potential impact of security breaches. The memory management module may employ a moving target defense mechanism that randomly changes memory addresses within compartments at runtime. The system may further comprise a threat detection module using AI algorithms to identify anomalous behavior, triggering dynamic memory adjustment and isolation of affected compartments. The memory management module may include a mechanism to shrink isolated memory compartments identified as potentially compromised, thus limiting access to system resources. The memory management module may integrate a self-healing mechanism to isolate compromised isolated memory compartments and restore them to a previous safe state. The system may be used to perform a method for dynamically adjusting isolated memory compartments in an IoT device, the method including: monitoring device behavior using embedded sensors to detect context changes; dynamically adjusting isolated memory compartment sizes based on detected context to enhance security; and periodically randomizing memory addresses within compartments to implement a moving target defense strategy. In this manner, implementations of the invention provide an improvement in the technology of cybersecurity in computer memory systems.

Implementations of the invention are necessarily rooted in computer technology because they involve using AI algorithms. For example, using AI algorithms to generate an output based on an input, such as using trained machine learning model to make a prediction based on a set of input data, is computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

Implementations of the invention are necessarily rooted in computer technology because they involve compartmentalizing the computer memory of an IoT device using a security capability architecture. A security capability architecture, such as a CHERI-based architecture, is implemented at the instruction set level of a computer. In computer technology, an instruction set is a group of commands for a central processing unit (CPU) in machine language. Machine language cannot be read or understood by humans. Therefore, aspects of the invention that involve compartmentalizing the computer memory of an IoT device using a security capability architecture cannot be performed mentally, since these aspects necessarily utilize machine language.

It should be understood that, to the extent implementations of the invention collect, store, or employ personal information provided by, or obtained from, individuals (for example, sensor data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic isolated memory compartmentalization code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

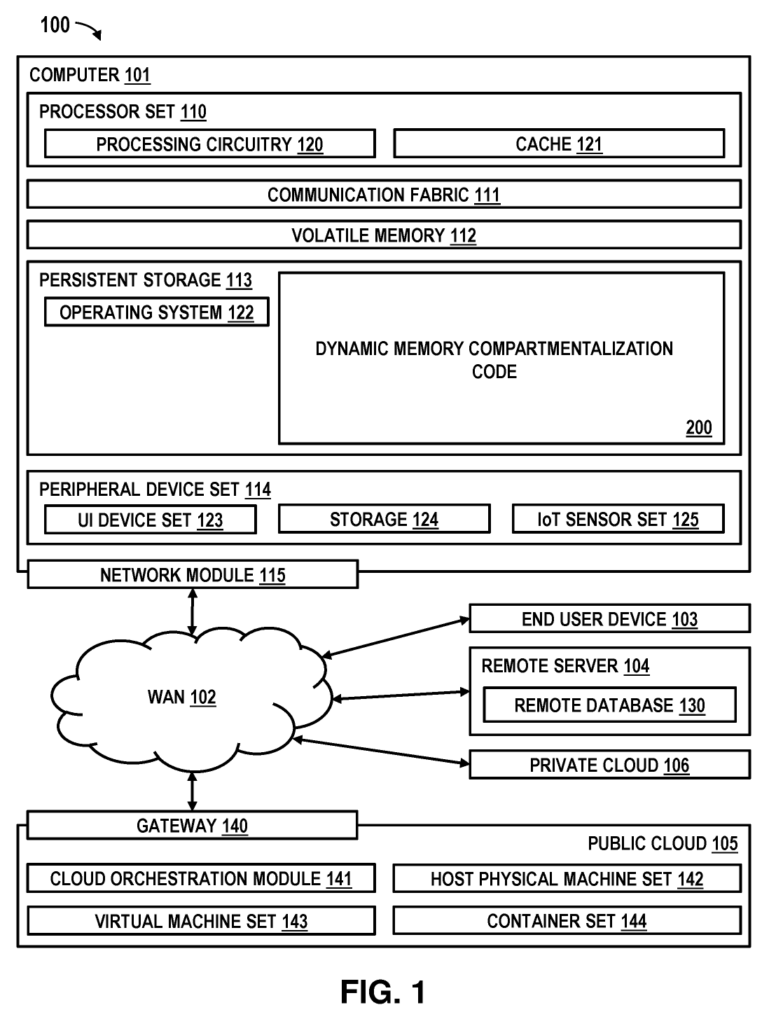

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

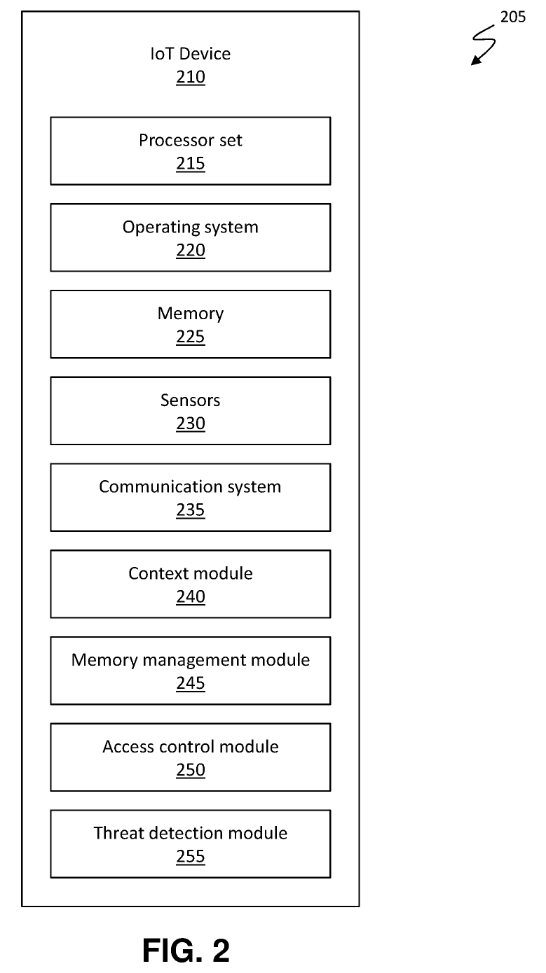

FIG. 2 shows a block diagram of an exemplary environment 205 in accordance with aspects of the invention. In embodiments, the environment 205 includes an IoT device 210 that includes a processor set 215, operating system 220, memory 225, sensors 230, communication system 235, context module 240, memory management module 245, access control module 250, and threat detection module 255. In various examples, the IoT device 210 comprises one or more instances of the computer 101 of FIG. 1, with the processor set 215 corresponding to processor set 110, the operating system 220 corresponding to operating system 122, the memory 225 corresponding to volatile memory 112 and/or persistent storage 113, the sensors 230 corresponding to IoT sensor set 125, and the communication system 235 corresponding to network module 115.

In various embodiments, access to the memory 225 is restricted by a system of capabilities using a security capability architecture. A “capability” is a term of art referring to an unforgeable digital token of authority that grants access to a specified memory address range. When a system of capabilities are enforced in hardware using a security capability architecture, this means that a machine code instruction that attempts to access some target address in memory, such as load or store instruction, will trigger a hardware check for a corresponding capability granting access the target address. The software in question must possess and be able to present the capability in order to be granted access. One example of a security capability architecture is CHERI (Capability Hardware Enhanced RISC (reduced instruction set computer) Instructions). CHERI is implemented by a system of fat pointers along with some dedicated additions to the instruction set architecture of the processor, e.g., the source operand of a traditional load instruction would typically specify a register holding a pointer to the target address (in this case the source of the load). In CHERI the instruction also needs to specify a register that holds a capability granting access to the target address, thus augmenting the pointer with the capability. The capabilities in the registers can only be manipulated by dedicated machine code instructions specially included in the instruction set according to the CHERI architecture. In various embodiments, the IoT device 210 employs a security capability architecture, such as a CHERI-based architecture, such that the memory 225 comprises a plurality of isolated memory compartments to which access is granted based on a capability as described above. As used herein, isolated memory compartments refers to isolated memory compartments of the memory 225 defined using a security capability architecture such as the CHERI architecture.

In embodiments, the IoT device 210 of FIG. 2 comprises the context module 240, memory management module 245, access control module 250, and threat detection module 255, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The IoT device 210 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the context module 240 is configured to determine an operational context associated with the IoT device 210. In embodiments, the context module 240 determines the context based on data from one or more of the sensors 230, which are embedded in the IoT device 210. The sensors 230 may include, but are not limited to, one or more from a group comprising: one or more location sensors that detect a location of the IoT device 210; one or more accelerometers that detect acceleration of the IoT device 210; one or more network activity monitors that detect network activity of the IoT device 210; one or more video/image sensors that obtain video/image data in a vicinity of the IoT device 210; one or more audio sensors that obtain audio data in a vicinity of the IoT device 210; one or more proximity sensors that detect a proximity of the IoT device 210 to another device, structure, or person; and one or more environmental sensors that detect one or more types of environmental data such as temperature, pressure, humidity, light levels, etc., in the vicinity of the IoT device 210. In various embodiments, the context module 240 is programmed with an AI algorithm (e.g., a context-determining machine learning model) that is trained to determine a current operational context of the IoT device 210 based on data from one or more of the sensors 230. In one example, the context-determining machine learning model is trained using supervised learning with labeled training data. For example, historic sets of sensor data may be labeled with respective ones of plural different contexts, and the context-determining machine learning model may be trained using this labeled training data. In another example, the context-determining machine learning model is trained using unsupervised learning with unlabeled training data. For example, the context-determining machine learning model may use clustering techniques with large batches of unlabeled sensor data to determine clusters of the sensor data, and the context-determining machine learning model may associate respective ones of plural different contexts with the respective ones of the clusters.

In accordance with aspects of the invention, the memory management module 245 is configured to dynamically adjust memory allocation within hardware-enforced compartments (i.e., the isolated memory compartments of the memory 225) based on real-time changes in the context determined by the context module 240. In embodiments, the memory management module 245 uses an AI algorithm (e.g., a memory baseline machine learning model that is different than the context-determining machine learning model) that is trained using unsupervised learning and with historic data associated with the IoT device 210 to learn memory access patterns and computational load on the IoT device 210 to establish a respective baseline of normal operation associated with each respective one of the operational contexts. For example, the memory baseline machine learning model may learn: during a first context determined by the context module 240, the IoT device 210 exhibits first memory access patterns amongst the isolated memory compartments of the memory 225 and a first computational load; during a second context determined by the context module 240, the IoT device 210 exhibits second memory access patterns amongst the isolated memory compartments of the memory 225 and a second computational load; during a third context determined by the context module 240, the IoT device 210 exhibits third memory access patterns amongst the isolated memory compartments of the memory 225 and a third computational load; etc. In this manner, the memory baseline machine learning model learns specific memory access patterns and computational loads associated with different ones of the operational contexts. In embodiments, the memory baseline machine learning model is trained using unsupervised learning and with historic data associated with the IoT device 210 to learn patterns that are specific to the IoT device 210.

In accordance with aspects of the invention, the memory management module 245 is further configured to dynamically adjust one or more of the isolated memory compartments of the memory 225 based on the current operational context of the IoT device 210 determined by the context module 240 and the baseline associated with the determined context. For example, based on the context module 240 determining the current operational context of the IoT device 210 is a first context, the memory management module 245 may dynamically adjust memory allocation of respective ones of the isolated memory compartments according to the baseline associated with the first context. This may comprise, for example, increasing the allocation of some of the isolated memory compartments and decreasing the allocation of other ones of the isolated memory compartments based on the first baseline. In this example, based on the context module 240 subsequently determining the current operational context of the IoT device 210 is a second context (i.e., the context changed from the first context to the second context), the memory management module 245 may dynamically adjust memory allocation of respective ones of the isolated memory compartments according to the baseline associated with the second context. This may comprise, for example, increasing the allocation of some of the isolated memory compartments and decreasing the allocation of other ones of the isolated memory compartments based on the second baseline. In this manner, the memory management module 245 may dynamically adjust one or more of the isolated memory compartments of the memory 225 based on a change in the current operational context of the IoT device 210.

In accordance with aspects of the invention, the memory management module 245 is further configured to employ a moving target defense mechanism that randomly changes (e.g., shuffles) memory addresses within the isolated memory compartments at runtime. In embodiments, the memory management module 245 implements a runtime address randomization mechanism to alter memory addresses dynamically, complicating potential exploitation by attackers. In various examples, the runtime address randomization periodically changes the memory addresses within each of the isolated memory compartments of the memory 225. In embodiments, the runtime address randomization occurs transparently to applications that use the memory 225 of the IoT device 210, ensuring continuous functionality while enhancing defense.

In accordance with aspects of the invention, the memory management module 245 is further configured to shrink the memory allocated to one of the isolated memory compartments identified as potentially compromised, thus limiting access to system resources. In embodiments, in response to the threat detection module 255 identifying a threat to one of the isolated memory compartments of the memory 225, the memory management module 245 automatically reduces the memory allocation for the compromised one of the isolated memory compartments, thereby limiting the ability of the threat to affect other parts of the system. In embodiments, the shrinking is performed as part of a dynamic memory adjustment process in which, based on the operational context and/or detected threats, memory allocation to various ones of the isolated memory compartments is dynamically adjusted. In the instance of a threat being detected for a respective one of the isolated memory compartments of the memory 225, the memory management module 245 optimizes the size of the respective one of the isolated memory compartments to increase security (e.g., shrinking those isolated memory compartments flagged as risky).

In accordance with aspects of the invention, the memory management module 245 is further configured to integrate a self-healing mechanism to quarantine compromised ones of the isolated memory compartments and restore them to a previous safe state. In embodiments, the memory management module 245 incorporates autonomous quarantine and recovery features, which contain threats and restore compartments to their last safe state. In various examples, the self-healing mechanisms (also called self-recovery mechanisms) implemented by the memory management module 245 include: an automatic quarantine feature to contain potentially compromised ones of the isolated memory compartments; and a rollback mechanism that can be triggered upon detection of an intrusion, restoring isolated memory compartments to their last known safe state. The rolling back may be performed using a snapshot or other technique for restoring a memory to a previous state.

In accordance with aspects of the invention, the access control module 250 is configured to restrict memory interactions between compartments to limit the potential impact of security breaches. In embodiments, the access control module 250 employs a security capability architecture, such as a CHERI-based architecture, such that the memory 225 comprises a plurality of isolated memory compartments that can only be accessed by software that is able to present a capability granting access the target address as described herein. In embodiments, the isolated memory compartments are created using a CHERI-based architecture with strict hardware-enforced access controls to limit unauthorized interactions between compartments. In embodiments, access control policies are defined for each one of the isolated memory compartments to ensure only authorized processes can access designated memory regions.

In accordance with aspects of the invention, the threat detection module 255 is configured to detect potential threats associated with one or more of the isolated memory compartments of the memory 225 of the IoT device 210. In embodiments, the threat detection module 255 utilizes one more AI algorithms to continuously analyze memory access patterns and detect abnormal behaviors associated with respective ones of the isolated memory compartments, such as buffer overflow attempts. In embodiments, for a given operational context determined by the context module 240, the threat detection module 255 utilizes the baseline associated with that context, real-time data from sensors 230, and anomaly detection algorithms to determine if the real-time behavior associated with a particular one of the isolated memory compartments indicates an unusual access pattern or unusual behavior compared to the baseline, signaling a potential threat. In some examples, the anomaly detection algorithms comprise one or more algorithms that compare the real-time data from one or more of the sensors 230 to the previously determined baseline for the current operational context, and indicate an anomaly (e.g., a threat) based on differences between the real-time data and the baseline exceeding a threshold. In some examples, the anomaly detection algorithms comprise one or more predictive models to identify potential memory threats before they occur, enabling proactive adjustments to memory compartments. The anomaly detection algorithms are not limited to this example, and other more sophisticated algorithms may be employed to compare the compare the real-time data from one or more of the sensors 230 to the previously determined baseline for the current operational context, and indicate an anomaly (e.g., a threat) based on the comparing.

In various embodiments, in response to detecting a potential threat to one of the isolated memory compartments in this manner, the threat detection module 255 may notify the memory management module 245 of the potential threat and the compromised one of the isolated memory compartments, at which point the memory management module 245 may perform actions associated with the compromised one of the isolated memory compartments such as dynamically adjusting (e.g., reducing) the memory allocation for the compromised one of the isolated memory compartments and/or performing a self-healing process to quarantine the compromised one of the isolated memory compartments and restore it to a previous safe state.

An exemplary implementation comprises a memory compartment setup, context monitoring and threat detection, dynamic memory adjustment, runtime address randomization, and self-recovery. In various embodiments, the memory compartment setup comprises the access control module 250 creating isolated memory compartments in the memory 225 using CHERI technology, with strict hardware-enforced access controls to limit unauthorized interactions between compartments. In embodiments, as part of the setup, the access control module 250 defines access control policies for each of the isolated memory compartments to ensure only authorized processes can access respective ones of the isolated memory compartments (e.g., via capabilities).

In various embodiments, the context monitoring of the exemplary implementation comprises the context module 240 determining a current operational context associated with the IoT device 210 based on data from one or more of the sensors 230. In various embodiments, the threat detection comprises the threat detection module 255 identifying a potential threat to a respective one of the isolated memory compartments of the memory 225 based on the current operational context (e.g., from the context module 240), a baseline associated with the current operational context, and real-time data from one or more of the sensors 230, e.g., using anomaly detection algorithms with the baseline and the real-time data to identify unusual access patterns or behaviors, signaling a potential compromise to the respective one of the isolated memory compartments.

In various embodiments, the dynamic memory adjustment of the exemplary implementation comprises the memory management module 245 dynamically adjusting respective sizes of one or more of the isolated memory compartments of the memory 225 based on the current operational context (e.g., from the context module 240), e.g., adjusting the size of one or more of the isolated memory compartments based on expected usage for the current operational context. In various embodiments, the dynamic memory adjustment of the exemplary implementation further comprises the memory management module 245 dynamically adjusting respective sizes of one or more of the isolated memory compartments of the memory 225 based on a potential threat detected by the threat detection module 255, e.g., shrinking the memory allocation of compromised ones of the isolated memory compartments.

In various embodiments, the runtime address randomization of the exemplary implementation comprises the memory management module 245 performing a moving target defense strategy that periodically changes memory addresses within each one of the isolated memory compartments of the memory 225. In embodiments, this address randomization occurs transparently to applications that utilize the memory 225, ensuring continuous functionality while enhancing defense.

In various embodiments, the self-recovery of the exemplary implementation comprises the memory management module 245 performing an automatic quarantine feature to contain potentially compromised ones of the isolated memory compartments of the memory 225. In embodiments, the memory management module 245 performs a rollback mechanism in response to the detection of potential threat by the threat detection module 255, restoring compromised ones of the isolated memory compartments to their last known safe state.

In an exemplary use case, the IoT device 210 is a smart security camera. In this example, the smart security camera performs context monitoring by monitoring its operational context, including network activity and environmental conditions, through embedded sensors (e.g., sensors 230). In this example, the smart security camera performs threat detection by detecting an anomaly in memory access patterns, indicative of a buffer overflow attempt. In this example, the smart security camera performs dynamic memory adjustment in response to detecting the threat by automatically reducing the memory allocated to the camera’s video processing application, thereby limiting the potential threat’s operational space. In this example, the smart security camera performs address randomization by periodically altering memory addresses, thereby implementing a moving target defense to complicate further exploitation attempts. In this example, the smart security camera performs self-recovery by quarantining the compromised one of the isolated memory compartments and rolling back the compromised one of the isolated memory compartments to a safe state, thereby minimizing the impact of the threat and restoring normal operations.

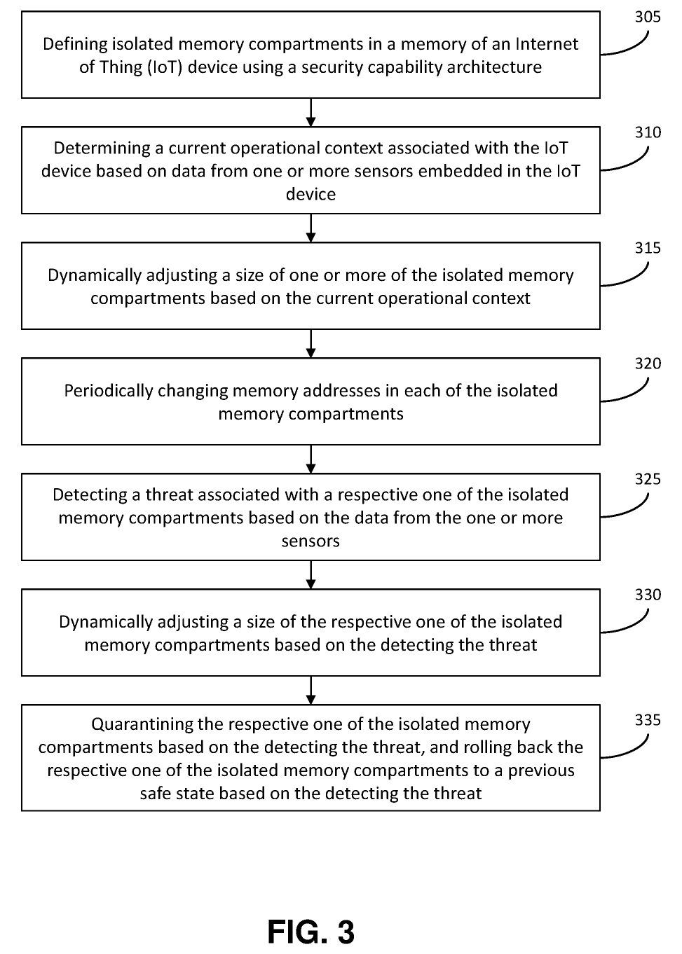

FIG. 3 shows a flowchart of an exemplary method in accordance with aspects of the present invention. Steps of the method (also referred to as operations) may be carried out in the environment of FIG. 2 and are described with reference to elements depicted in FIG. 2.

At step 305 the system defines isolated memory compartments in a memory of an Internet of Thing (IoT) device using a security capability architecture. In embodiments, and as described with respect to FIG. 2, the access control module 250 defines the isolated memory compartments in the memory 225 of the IoT device 210.

At step 310 the system determines a current operational context associated with the IoT device based on data from one or more sensors embedded in the IoT device. In embodiments, and as described with respect to FIG. 2, the context module 240 determines the current operational context using data from one or more of the sensors 230.

At step 315 the system dynamically adjusts a size of one or more of the isolated memory compartments based on the current operational context. In embodiments, and as described with respect to FIG. 2, the memory management module 245 dynamically adjusts a size of one or more of the isolated memory compartments based on the current operational context determined by the context module 240, e.g., to adjust the size to the expected usage for the current operational context.

At step 320 the system periodically changes memory addresses in each of the isolated memory compartments. In embodiments, and as described with respect to FIG. 2, the memory management module 245 periodically randomizes the memory addresses.

At step 325 the system detects a threat associated with a respective one of the isolated memory compartments based on the data from the one or more sensors. In embodiments, and as described with respect to FIG. 2, the threat detection module 255 detects a potential threat based on the data from one or more of the sensors 230 and the based on the current operational context.

At step 330 the system dynamically adjusts a size of the respective one of the isolated memory compartments based on the detecting the threat. In embodiments, and as described with respect to FIG. 2, the memory management module 245 dynamically adjusts a size of a compromised one or more of the isolated memory compartments based on the detected threat associated with the compromised one or more of the isolated memory compartments.

At step 335 the system quarantines the respective one of the isolated memory compartments based on the detecting the threat and rolls back the respective one of the isolated memory compartments to a previous safe state based on the detecting the threat. In embodiments, and as described with respect to FIG. 2, the memory management module 245 performs the quarantine and rolling back of the compromised one or more of the isolated memory compartments.

In various embodiments of the method, the current operational context is determined using a first machine learning model. Various embodiments of the method further comprise determining a baseline associated with the current operational context using a second machine learning model that is different than the first machine learning model. In various embodiments of the method, the threat is detected using the baseline associated with the current operational context, the data from the one or more sensors, and one or more anomaly detection algorithms.

In various embodiments of the method, the security capability architecture comprises capability hardware enhanced reduced instruction set computer instructions (CHERI).

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
defining isolated memory compartments in a memory of an Internet of Things (IoT) device using a security capability architecture;
determining a current operational context associated with the IoT device based on data from one or more sensors embedded in the IoT device;
detecting a threat associated with a respective one of the isolated memory compartments based on the current operational context and the data from the one or more sensors; and
dynamically adjusting a size of the respective one of the isolated memory compartments based on the detecting the threat.

2. The method of claim 1, further comprising:
quarantining the respective one of the isolated memory compartments based on the detecting the threat; and
rolling back the respective one of the isolated memory compartments to a previous safe state based on the detecting the threat.

3. The method of claim 1, further comprising dynamically adjusting a size of one or more of the isolated memory compartments based on the current operational context.

4. The method of claim 1, further comprising periodically shuffling memory addresses in each of the isolated memory compartments.

5. The method of claim 1, wherein the current operational context is determined using a first machine learning model.

6. The method of claim 5, further comprising determining a baseline associated with the current operational context using a second machine learning model that is different than the first machine learning model.

7. The method of claim 6, wherein the threat is detected using the baseline associated with the current operational context, the data from the one or more sensors, and one or more anomaly detection algorithms comprising one or more predictive models configured to identify potential memory threats before they occur.

8. The method of claim 1, wherein the security capability architecture comprises capability hardware enhanced reduced instruction set computer instructions.

9. A computer program product comprising:
one or more computer-readable storage media; and
program instructions stored on the one or more computer-readable storage media to perform operations comprising:
defining isolated memory compartments in a memory of an Internet of Things (IoT) device using a security capability architecture;
determining a current operational context associated with the IoT device based on data from one or more sensors embedded in the IoT device;
detecting a threat associated with a respective one of the isolated memory compartments based on the current operational context and the data from the one or more sensors;
dynamically adjusting a size of the respective one of the isolated memory compartments based on the detecting the threat;
quarantining the respective one of the isolated memory compartments based on the detecting the threat; and
rolling back the respective one of the isolated memory compartments to a previous safe state based on the detecting the threat.

10. The computer program product of claim 9, further comprising dynamically adjusting a size of one or more of the isolated memory compartments based on the current operational context.

11. The computer program product of claim 9, further comprising periodically changing memory addresses in each of the isolated memory compartments.

12. The computer program product of claim 9, wherein:
the current operational context is determined using a first machine learning model;
a baseline associated with the current operational context is determined using a second machine learning model that is different than the first machine learning model; and
the threat is detected using the baseline associated with the current operational context, the data from the one or more sensors, and one or more anomaly detection algorithms.

13. The computer program product of claim 9, wherein the security capability architecture comprises capability hardware enhanced reduced instruction set computer instructions.

14. A computer system comprising:
a processor set;
one or more computer-readable storage media; and
program instructions stored on the one or more computer-readable storage media to cause the processor set to perform operations comprising:
defining isolated memory compartments in a memory of an Internet of Things (IoT) device using a security capability architecture;
determining a current operational context associated with the IoT device based on data from one or more sensors embedded in the IoT device;
dynamically adjusting a size of one or more of the isolated memory compartments based on the current operational context; and
periodically changing memory addresses in each of the isolated memory compartments.

15. The computer system of claim 14, wherein the operations further comprise:
detecting a threat associated with a respective one of the isolated memory compartments based on the data from the one or more sensors; and
dynamically adjusting a size of the respective one of the isolated memory compartments based on the detecting the threat.

16. The computer system of claim 15, wherein the operations further comprise:
quarantining the respective one of the isolated memory compartments based on the detecting the threat; and
rolling back the respective one of the isolated memory compartments to a previous safe state based on the detecting the threat.

17. The computer system of claim 15, wherein the current operational context is determined using a first machine learning model.

18. The computer system of claim 17, wherein the operations further comprise determining a baseline associated with the current operational context using a second machine learning model that is different than the first machine learning model.

19. The computer system of claim 18, wherein the threat is detected using the baseline associated with the current operational context, the data from the one or more sensors, and one or more anomaly detection algorithms.

20. The computer system of claim 14, wherein the security capability architecture comprises capability hardware enhanced reduced instruction set computer instructions.
